(19) United States
(12) Patent Application Publication
(10) Pub. No.: US 2009/0038924 A1
(43) Pub. Date: Feb. 12, 2009

(54) AUTOMATIC TIMING SWITCH DEVICE

(75) Inventors: Keng-Jen LAI, Hsinchu (TW); Ming-Teng CHU, Hsinchu (TW); Shih-Chi CHAN, Hsinchu (TW)

Correspondence Address: Workman Nydegger;1000 Eagle Gate Tower, 60 East South Temple, Salt Lake City, UT, 84111, US

(73) Assignee: NORM PACIFIC AUTOMATION CORP., Hsinchu (TW)

(21) Appl. No.: 11/835,497

(22) Filed: Aug. 8, 2007

(51) Int. Cl. H01H 7/08

(52) U.S. Cl. 200/38 C

(57) ABSTRACT

An automatic timing switch device includes a switch control wheel, a driving assembly, and a plurality of push switches. The switch control wheel includes a plurality of wheel-shaped structures stacked sequentially, wherein each of the wheel-shaped structures has at least one notch formed on an outer periphery of the switch control wheel, and the diameters of the wheel-shaped structures reduce sequentially so that the switch control wheel is in tapered shape. The driving assembly drives the switch control wheel to rotate. The push switches are switched by engaging into or separating from the notches of the wheel-shaped structures as the switch control wheel rotated by the driving assembly. Since the switch control wheel is in a tapered shape, so that the switch control wheel is easily to be formed monolithically and is convenient to be installed to the case of the automatic timing switch device.

### BACKGROUND OF THE INVENTION

1. Field of Invention

The present invention relates to an automatic timing switch device, and more particularly to an automatic timing switch device that is easy to be fabricated and installed.

2. Related Art

A common automatic timing switch device for a washing machine or a dryer includes time control wheel having a plurality of disks or cams stacked one by one coaxially on a rotating shaft. The disks or cams have protrusions or notches, and each of the protrusions or notches is in contact with a push switch. When the rotating shaft rotates, the time control wheel is driven to rotate, such that the push switches are engaged into or separated from the notches, so as to turn on or turn off the push switches. After the push switches are turned on, different operations will be executed, such that the washing machine or the dryer performs different operations at different time. For example, U.S. Pat. No. 7,009,122 discloses an automatic timing switch device, which includes time control wheel having a plurality of cams stacked on a rotating shaft for controlling different switches respectively The cams have same the diameters while the push switches are disposed into the case of the automatic timing switch device in advance. To install the cams having the same diameter into the case, the push switches have to be pressed away, that is, it is inconvenient to install the cams into the housing of the automatic timing switch device. Therefore, the automatic timing switch device costs much labor force and time to assemble, which not only increases the manufacturing cost, but also reduces the efficiency to assemble the product.

### SUMMARY OF THE INVENTION

Accordingly, the object of the present invention is to provide a timing switch device that in convenient to be assembled, which reduces the time required to assemble the timing switch device and the manufacturing cost.

In order to achieve the aforementioned object, an automatic timing switch device of the present invention is provided, which includes a switch control wheel, a driving assembly, and a plurality of push switches. The switch control wheel includes a plurality of wheel-shaped structures stacked sequentially, wherein each of the wheel-shaped structures has at least one notch formed on an outer periphery of the switch control wheel, and the diameters of the wheel-shaped structures reduce sequentially so that the switch control wheel is in tapered shape. The driving assembly is used for driving the switch control wheel to rotate. The push switches are switched by engaging the into or separating from the notches of the wheel-shaped structures as the switch control wheel rotated by the driving assembly, so as to activated or deactivated different operations of a washing machine or a dryer having the automatic timing switch device.

The advantage of the present invention is that the structure of the switch control wheel of the automatic timing switch device is in a tapered shape, which is helpful to form the wheel monolithically, such that switch control wheel is simplified to a single element. Therefore, when the automatic timing switch device is assembled, the process of assembling and the elements are greatly simplified, so the process becomes less complicated, and the manufacturing cost and the waste of labor force and time are reduced. Thus, the efficiency to manufacture the product is improved. Even though the wheel is not formed monolithically and is formed by stacking wheel-shaped structures, the tapered shape of the wheel is convenient to be install into case of the automatic timing switch device, so as to increasing the manufacturing efficiency and reducing the manufacturing cost.

The description on the content of the present invention above and the description on the embodiments below are used to exemplify and explain the principle of the present invention, and provide further explanation on the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic exploded view of the automatic timing switch device according to a first embodiment of the present invention;

FIG. 1B is a schematic partial combined view of the automatic timing switch device according to the first embodiment of the present invention;

FIG. 1C is a schematic exploded view of the driving assembly of the automatic timing switch device according to the first embodiment of the present invention;

FIG. 2 is a schematic view of the switch control wheel of the automatic timing switch device according to the first embodiment of the present invention;

FIGS. 3A and 3B are schematic views of working steps of the automatic timing switch device according to the first embodiment of the the present invention;

FIG. 4A is a schematic combined view of a switch control wheel of a second embodiment of the present invention; and

FIG. 4B is a schematic exploded view of the switch control wheel of the second embodiment of the present invention.

### DETAILED DESCRIPTION OF THE INVENTION

In order to make the objects, structure, features and functions of the present invention more understandable, the present invention is illustrated below in detail with reference to the embodiments.

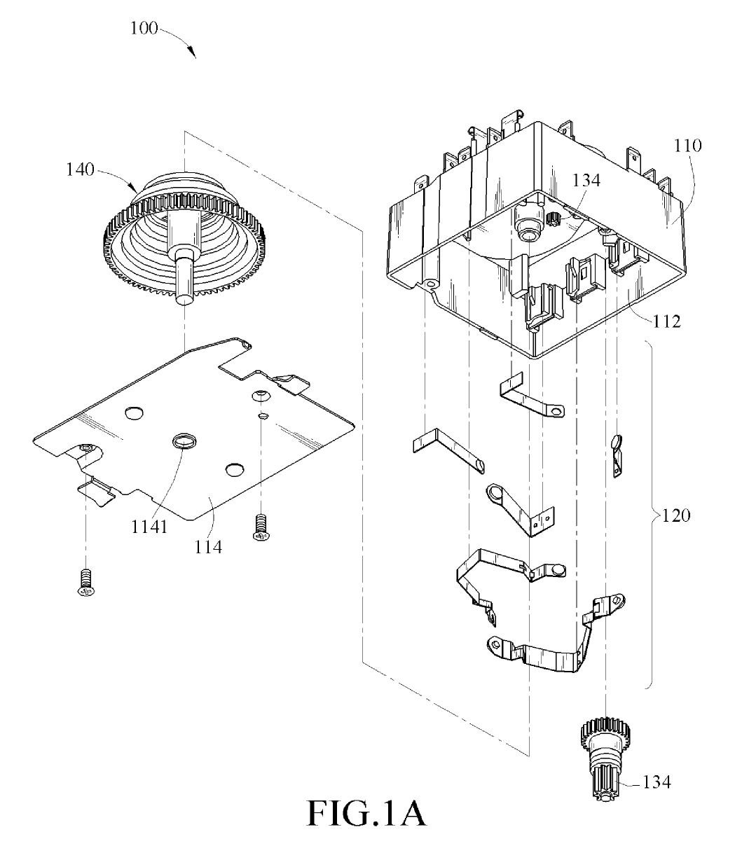

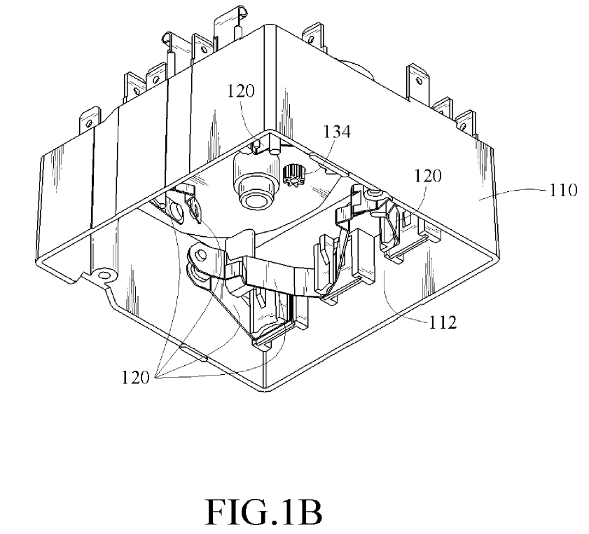

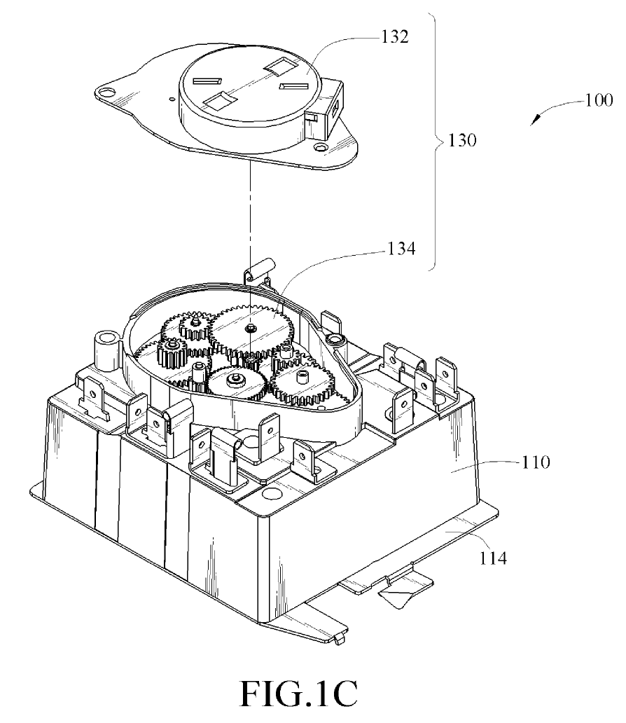

Referring to FIGS. 1A, 1B, and 1C, an automatic timing switch device 100 of a first embodiment of the present invention is shown, which includes a case 110, a driving assembly 130, a plurality of push switches 120, and a switch control wheel 140. The automatic timing switch device 100 is generally applied in home appliances, such as washing machines and dryers, for activating or deactivating different operating functions in a time sequence.

Referring to FIG. 1A and FIG. 1C again, the case 110 has an accommodation space 112 for accommodating the push switches 120 and the switch control wheel 140, and the switch control wheel 140 is pivoted to the case 110. A cover 114 is mounted to the case 110 to enclose the accommodation space 112. The driving assembly 130 is disposed outside the case 110 for driving the switch control wheel 140 to rotate. The driving assembly 130 includes a motor 132 and a gear set 134 driven by the motor 132. The gear set 134 extends into the accommodation space 112 of the case 110 from a through hole in the case 110, so as to be engaged with the switch control wheel 140 to drive the switch control wheel 140 to rotate through the motor 132.

Referring to FIGS. 1A and 1B again, the push switches 120 are disposed in the accommodation space of the case 110, and are arranged around the switch control wheel 140. The push switches 110 are arranged at planes of different heights, so as to contact different parts of the switch control wheel 140. The other ends of the push switches 120 are connected to different control circuits (not shown) respectively, so as to activate or deactivate different operations when the push switches 120 are turned on. Taking an automatic timing switch device 100 applied in a washing machine as an example, the operations include water injection, washing, water discharging, spinning and etc. In addition, in the first embodiment, each of the push switches 120 includes two conductive reeds. When the two conductive reeds are in contact with the switch control wheel 140, and are pressed, such that the two conductive springs contact each other, the push switch 120 will be turned on to execute one of the aforementioned operations.

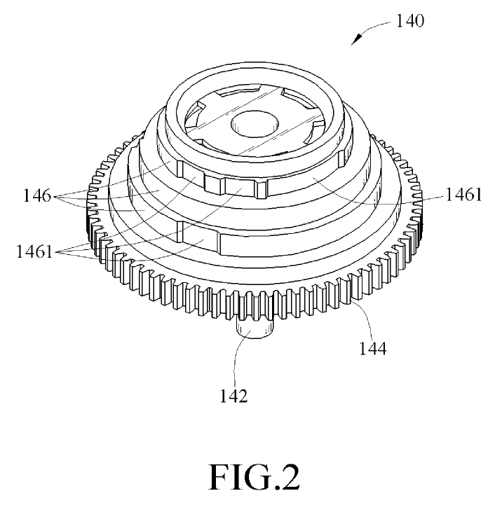

Referring to FIG. 2, the switch control wheel 140 has a rotating shaft 142, a plurality of wheel-shaped structures 146, and a wheel-shaped gear structure 144. The wheel-shaped structures 146 of the switch control wheel 140 are formed monolithically, and the wheel-shaped structures 146 are stacked sequentially. The diameters of the wheel-shaped structures 146 reduce sequentially, such that the switch control wheel 140 is in a tapered shape. The tapered shape is helpful to form the witch control wheel 140 monolithically by insert molding, so as to reduce the time and process to fabricate the switch control wheel 140.

Each of the wheel-shaped structures 146 has at least one notch 1461 formed in the outer periphery of the switch control wheel 140. The switch control wheel 140 contacts the push switches 120 with the wheel-shaped structure 146, i.e., the wheel-shaped structure 146 contacts with one of the push switches 120. When one of the conductive reeds of each of the push switches 120 engages into or separates from the notch 1461 as the switch control wheel 140 rotated by the driving assembly 130, the push switches 120 are switched to be turned on or turned off. Besides, the wheel-shaped gear structure 144 is formed at the top end of the switch control wheel 140 and engaged the gear set 134 of the driving assembly 130, such that the switch control wheel 140 is rotated by the driving assembly 130. The rotating shaft 142 of the switch control wheel 140 is also formed monolithically at the bottom end of the driving assembly 130. When being assembled in the case 110, the rotating shaft 142 extends outward from a drill hole 1141 of the cover 114, as shown in FIG. 1B.

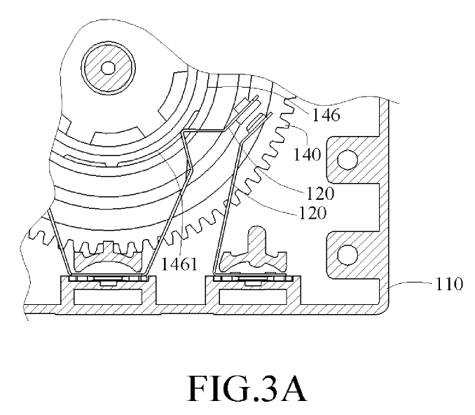

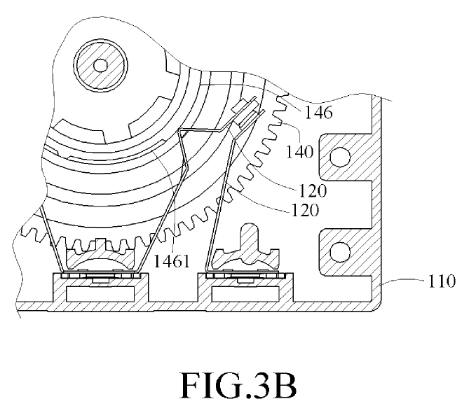

FIGS. 3A and 3B are schematic exploded views of working steps of the automatic timing switch device according to the present invention. The wheel-shaped structures 146 of the switch control wheel 140 according to the present invention are stacked one by one that the diameters reduce sequentially. Therefore, when the switch control wheel 140 is disposed in the accommodation space 112 of the case 110, as the push switches 120 are disposed at planes of different heights of the automatic timing switch device 100, the wheel-shaped structures 146 stacked on the switch control wheel 140 sequentially will contact the push switches 120 at the planes of different heights respectively to activate or deactivate different operations. As shown in FIG. 3A, when the switch control wheel 140 is rotated to correspond the notch 1461 of the wheel-shaped structure 146 to one of the push switches 120, one of the conductive reeds of the push switch 120 engages into notch 1461, such that the two conductive reeds of the push switch 120 are separated, so the push switch 120 is turned off. As shown in FIG. 3B, when one of the conductive reeds of the push switch 120 is separated from the notch 1461, and contacts the wheel-shaped structure 146 and is pressed, the two conductive reeds of the push switch 120 are electrically connected, and the push switch 120 is turned on.

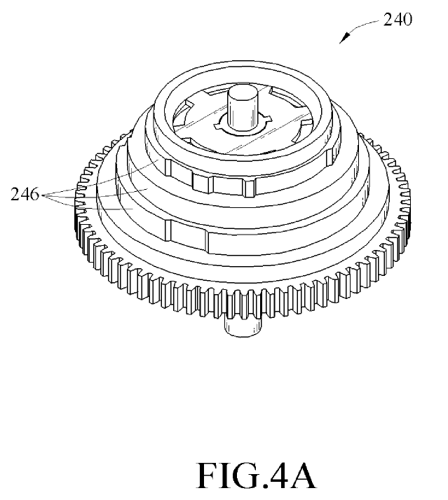

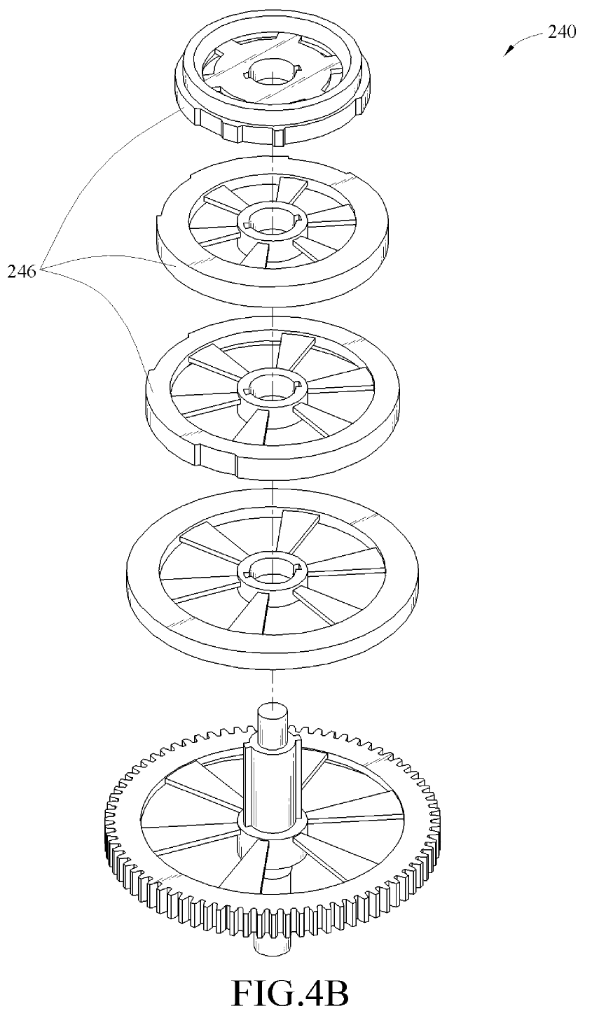

Referring to FIGS. 4A and 4B, a switch control wheel 240 of a second embodiment of the present invention is shown. The switch control wheel 240 includes a plurality of wheel-shaped structures 246. The wheel-shaped structures 246 in the second embodiment are formed individually, and are stacked one by one to form the switch control wheel 240. The diameters of the wheel-shaped structures 246 reduce sequentially, such that the switch control wheel 240 is in tapered shape which is convenient for the switch control wheel 240 to be installed into case of the automatic timing switch device.

The size of the wheel-shaped structure of switch control wheel of the automatic timing switch device of the present invention makes the switch control wheel have a tapered shape. The tapered shape is helpful to form the switch control wheel monolithically, such that the switch control wheel is simplified to a single element. Therefore, when the automatic timing switch device is assembled, the assembling process and the elements are also simplified greatly. Thus, the process becomes less complicated, the manufacturing cost and the labor force and time are reduced, and the efficiency to manufacture the product is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An automatic timing switch device, comprising:
a switch control wheel, including a plurality of wheel-shaped structures stacked sequentially, wherein each of the wheel-shaped structures has at least one notch formed on an outer periphery of the switch control wheel, and the diameters of the wheel-shaped structures reduce sequentially so that the switch control wheel is in tapered shape;
a driving assembly, driving the switch control wheel to rotate; and
a plurality of push switches, switched by engaging the into or separating from the notches of the wheel-shaped structures as the switch control wheel rotated by the driving assembly.

2. The automatic timing switch device as claimed in claim 1, wherein the switch control wheel further comprises a wheel-shaped gear structure formed at a top end of the switch control wheel and engaged with the driving assembly.

3. The automatic timing switch device as claimed in claim 1, wherein each of the push switches includes two conductive reeds, and the push switches are switched by engaging one of the conductive reeds into or separating one of the conductive reeds from each of the notches.

4. The automatic timing switch device as claimed in claim 3, wherein the push switches are disposed at planes of different heights of the automatic timing switch device, such that the wheel-shaped structures stacked sequentially contact the push switches at the planes of different heights.

5. The automatic timing switch device as claimed in claim 1, further comprising a case for accommodating the push switches and the switch control wheel, wherein the switch control wheel is pivoted to the case, and the driving assembly is disposed on the case, so as to drive the switch control wheel to rotate.

6. The automatic timing switch device as claimed in claim 1, wherein the wheel-shaped structures are formed monolithically.

7. The automatic timing switch device as claimed in claim 1, wherein the wheel-shaped structures are stacked one by one to form the switch control wheel.
